(19) United States
(12) Patent Application Publication
(10) Pub. No.: US 2017/0264346 A1
(43) Pub. Date: Sep. 14, 2017

(54) System and Method for Communicating in a Wireless Communications System with Precoding

(71) Applicant: Futurewei Technologies, Inc., Plano, TX (US)

(72) Inventors: Guosen Yue, Edison, NJ (US); Bohan Zhang, Edison, NJ (US); Xiao-Feng Qi, Westfield, NJ (US)

(21) Appl. No.: 15/065,229

(22) Filed: Mar. 9, 2016

(51) Int. Cl. H04B 7/04; H04L 5/00

(52) U.S. Cl. CPC H04B 7/0452; H04B 7/0417; H04L 5/0026; H04L 5/0053

(57) ABSTRACT

A method for precoded communications includes precoding in a first stage, outgoing data streams with first precoding matrices generated in accordance with instantaneous channel feedback received from receiving devices, wherein a configuration of the instantaneous channel feedback is determined in accordance with statistical channel information and individual of the receiving devices, thereby producing first precoded data streams, precoding in a second stage, the first precoded data streams with second precoding matrices generated in accordance with the statistical channel information associated with the receiving devices, thereby producing second precoded data streams, and transmitting the second precoded data streams to the receiving devices.

### TECHNICAL FIELD

The present disclosure relates generally to digital communications, and more particularly to a system and method for communicating in a wireless communications system with precoding.

### BACKGROUND

Many modern wireless communications systems, such as large scale multiuser multiple input multiple output (MU-MIMO) communications systems, depend upon fairly accurate channel state information (CSI) in order to enable good MU-MIMO performance. Precoding is a form of beamforming used to support multi-stream (or multi-layer) transmission. Information being transmitted to a receiving device is multiplied by precoding coefficients of a precoding matrix in order to maximize the signal at the receiving device and mitigate the interference from data signals of other users. The precoding matrix is derived from the CSI. As an example, in a time division duplexed (TDD) wireless communications system, downlink CSI may be obtained from uplink CSI due to downlink-uplink channel reciprocity. However, the complexity of MU-MIMO user pairing and precoding is high. While in a frequency division duplexed (FDD) wireless communications system, feedback from receiving devices (e.g., users) are used to obtain the downlink CSI. Due to the large number of antennas, which is expected to continue to increase in a dramatic fashion in the future, feedback overhead is very high and negatively impacts the overall performance of the wireless communications system.

### SUMMARY OF THE DISCLOSURE

Example embodiments provide a system and method for communicating in a wireless communications system with precoding.

In accordance with an example embodiment, a method for performing precoded communications is provided. The method includes precoding in a first stage of a transmitting device, outgoing data streams with first precoding matrices generated in accordance with instantaneous channel feedback received from receiving devices, wherein a configuration of the instantaneous channel feedback is determined in accordance with statistical channel information and individual measures of the receiving devices, thereby producing first precoded data streams, precoding in a second stage of the transmitting device, the first precoded data streams with second precoding matrices generated in accordance with the statistical channel information associated with the receiving devices, thereby producing second precoded data streams, and transmitting, by the transmitting device, the second precoded data streams to the receiving devices.

In accordance with another example embodiment, a method for digital communications is provided. The method includes determining, by a transmitting device, groupings of receiving devices in accordance with statistical channel information associated with the receiving devices, thereby producing a plurality of receiving device groups, generating, by the transmitting device, a second precoding matrix for each receiving device group of the plurality of receiving device groups, wherein the second precoding matrix is generated in accordance with the statistical channel information associated with the receiving devices, determining, by the transmitting device, groupings of channel feedback devices in accordance with the statistical channel information associated with the receiving devices and individual measures of each of the receiving devices, thereby producing a plurality of channel feedback groups, generating, by the transmitting device, a first precoding matrix for each channel feedback group of the plurality of channel feedback groups, where the first precoding matrix is generated in accordance with instantaneous channel feedback received from the receiving devices, and multiplying, by the transmitting device, outgoing data streams with the first precoding matrix and the second precoding matrix.

In accordance with an example embodiment, a non-transitory computer-readable medium storing programming for execution by a processor is provided. The programming including instructions to precode in a first stage of a transmitting device, outgoing data streams with first precoding matrices generated in accordance with instantaneous channel feedback received from receiving devices, wherein a configuration of the instantaneous channel feedback is determined in accordance with statistical channel information and individual measures of the receiving devices, thereby producing first precoded data streams, precode in a second stage of the transmitting device, the first precoded data streams with second precoding matrices generated in accordance with the statistical channel information associated with the receiving devices, thereby producing second precoded data streams, and transmit the second precoded data streams to the receiving devices.

In accordance with an example embodiment, a non-transitory computer-readable medium storing programming for execution by a processor is provided. The programming including instructions to determine groupings of receiving devices in accordance with statistical channel information associated with the receiving devices, thereby producing a plurality of receiving device groups, generate a second precoding matrix for each receiving device group of the plurality of receiving device groups, wherein the second precoding matrix is generated in accordance with the statistical channel information associated with the receiving devices, determine groupings of channel feedback devices in accordance with the statistical channel information associated with the receiving devices and individual measures of each of the receiving devices, thereby producing a plurality of channel feedback groups, generate a first precoding matrix for each channel feedback group of the plurality of channel feedback groups, where the first precoding matrix is generated in accordance with instantaneous channel feedback received from the receiving devices, and multiply outgoing data streams with the first precoding matrix and the second precoding matrix.

Practice of the foregoing embodiments provide a system and method for communicating in wireless communications systems with precoding that uses intergroup channel feedback to limit feedback overhead, thereby limiting the increase in communications overhead as the number of antennas increase while improving overall communications system performance.

### BRIEF DESCRIPTION OF THE DRAWINGS

For a more complete understanding of the present disclosure, and the advantages thereof, reference is now made to the following descriptions taken in conjunction with the accompanying drawing, in which:

FIG. 1 illustrates an example communications system highlighting downlink MU-MIMO operations according to example embodiments described herein;

FIG. 2 illustrates an example communications system highlighting downlink MU-MIMO operations with grouped users according to example embodiments described herein;

FIG. 3 illustrates an example communications system highlighting interference according to example embodiments described herein;

FIG. 4 illustrates a diagram highlighting two clusters of scatter rings according to example embodiments described herein;

FIG. 5 illustrates a flow diagram of example high-level operations occurring in a transmitting device using two-stage precoding with intra-group and inter-group feedback according to example embodiments described herein;

FIG. 6 illustrates a flow diagram of first example operations occurring in a transmitting device using two-stage precoding with intra-group and inter-group feedback according to example embodiments described herein;

FIG. 7 illustrates a flow diagram of second example operations occurring in a transmitting device using two-stage precoding with intra-group and inter-group feedback according to example embodiments described herein;

FIG. 8 illustrates an example processing unit for two-stage precoding data streams with intra-group and inter-group feedback according to example embodiments described herein;

FIG. 9A illustrates a block diagram of a first embodiment transmitting device according to example embodiments described herein;

FIG. 9B illustrates a block diagram of a second embodiment transmitting device according to example embodiments described herein;

FIG. 10 illustrates a block diagram of an embodiment processing system for performing methods described herein; and

FIG. 11 illustrates a block diagram of a transceiver adapted to transmit and receive signaling over a telecommunications network according to example embodiments described herein.

### DETAILED DESCRIPTION OF ILLUSTRATIVE EMBODIMENTS

The operating of the current example embodiments and the structure thereof are discussed in detail below. It should be appreciated, however, that the present disclosure provides many applicable inventive concepts that can be embodied in a wide variety of specific contexts. The specific embodiments discussed are merely illustrative of specific structures of the embodiments and ways to operate the embodiments disclosed herein, and do not limit the scope of the disclosure.

One embodiment relates to communicating in a wireless communication system with precoding. For example, a transmitting device precodes in a first stage, outgoing data streams with first precoding matrices generated in accordance with instantaneous channel feedback received from receiving devices, wherein a configuration of the instantaneous channel feedback is determined in accordance with statistical channel information and individual of the receiving devices, thereby producing first precoded data streams, precodes in a second stage, the first precoded data streams with second precoding matrices generated in accordance with the statistical channel information associated with the receiving devices, thereby producing second precoded data streams, and transmits the second precoded data streams to the receiving devices.

The embodiments will be described with respect to example embodiments in a specific context, namely large scale MU-MIMO communication systems that use precoding to improve communication performance. The embodiments may be applied to standards compliant large scale MU-MIMO communications systems, such as those that are compliant with Third Generation Partnership Project (3GPP), IEEE 802.11, and the like, technical standards, and non-standards compliant large scale MU-MIMO communications systems, that use precoding to improve communications performance.

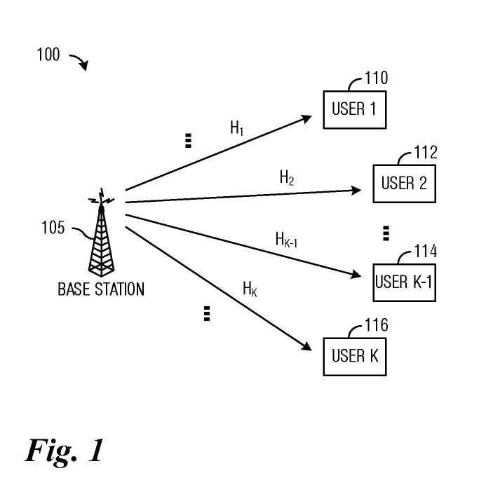

FIG. 1 illustrates an example communications system 100 highlighting downlink MU-MIMO operations. Communications system 100 includes a base station (BS) 105 serving a plurality of users, including user 1 110, user 2 112, user K-1 114, and user K 116, where K is a non-negative integer value. BS 105 includes M_{T} transmit antennas, where M_{T} is greater than or equal to K. A BS may also be commonly referred to as a controller, a NodeB, an evolved NodeB (eNB), an access point, and the like, while a user may also be commonly referred to as a mobile station, a mobile, a subscriber, a terminal, a station, a user equipment (UE), and so on. For discussion purposes, in a downlink transmission, the BS (and equivalently a controller, a NodeB, an eNB, an access point, and the like) is the transmitting device and the user device (and equivalently a mobile station, a mobile, a subscriber, a terminal, a station, a UE, and so on) is the receiving device, while in an uplink transmission, the user device is the transmitting device and the BS is the receiving device. Although the discussion presented herein focuses on situations where the BS is the transmitting device and the user device is the receiving device, the example embodiments presented in this disclosure are operable with the user being the transmitting device and the BS being the receiving device.

While it is understood that communications systems may employ multiple BS s capable of communicating with a number of users, only one BS, and a number of users are illustrated for simplicity.

The transmit antennas of BS 105 may have different geometries, such as a uniform linear array (ULA), a circular array, a two-dimensional plane array, and the like. For discussion purposes, consider a situation where K users are served simultaneously by BS 105. The signals received by all users, y, may be expressed as

y=H^{H}x+n, (1)

where H (with dimension M_{T}×K) is the channel matrix between BS 105 and the K users, H includes K vectors (with dimension M_{T}×1) representing channels between BS 105 and each of the K users, x (with dimension M_{T}×1) is the transmitted signal vector, and (.)^{H} is the matrix Hermitian.

When linear precoding is used, the transmitted signal vector is expressible as

x=Vs, (2)

where V (with dimension M_{T}×K) is the precoding matrix for the K users and s (with dimension K×1) is the data symbol vector for the K users.

Two-stage precoding involves the product of two precoding matrices and may be expressible as

V=ζBP, (3)

where P (with dimension b×K) is a first precoding matrix (denoted a first-stage precoding matrix), B (with dimension M_{T}×b) is a second precoding matrix (denoted a pre-beamforming matrix), and (is a normalization factor. The first precoding matrix is dynamic in nature and is based on instantaneous channel information, while the second precoding matrix is based on statistical channel information, such as downlink transmit covariance. The K users are divided into groups and the same second precoding matrix is applied to the data symbols for all of the users in each group.

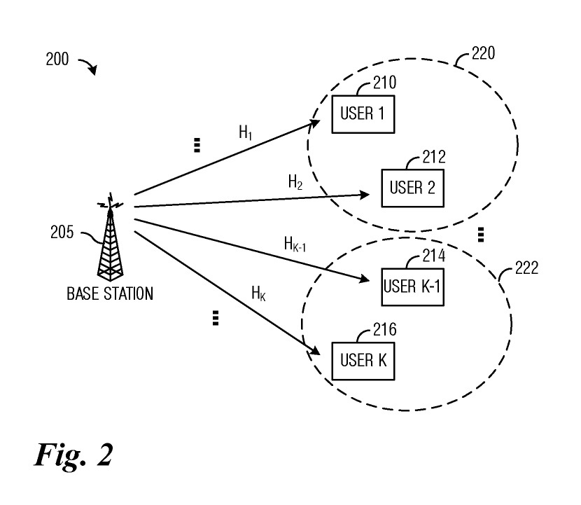

FIG. 2 illustrates an example communications system 200 highlighting downlink MU-MIMO operations with grouped users. Communications system 200 includes a BS 205 serving a plurality of users, including user 1 210, user 2 212, user K-1 214, and user K 216. BS 205 includes M_{T} transmit antennas, where M_{T} is greater than or equal to K. The K users are divided into groups, including a first group 220 including user 1 210 and user 2 212, and a second group 222 including user K-1 214 and user K 216. As an example, the users may be grouped by their channel statistics. In other words, users with the same or similar channel statistics are grouped together. Although FIG. 2 illustrates a situation with two groups and each group including two users, there may be any arbitrary number of groups (up to a maximum of K groups) and each group may include one or more users.

In two-stage precoding, the same pre-beamforming matrix is applied to the users of a single group. Typically, in a geographical area covered by a macro base station, the users will have different channel statistics. In order to design the pre-beamforming matrix, users are placed into groups where the users of a single group have the same or similar channel statistics, where the users are deemed to have similar channel statistics if their channel statistics differ by less than a specified threshold. The pre-beamforming matrix may be designed based on the channel correlations for all groups. For discussion purposes, consider a situation where there are G groups, then the pre-beamforming matrix may be represented as B=[B₁, . . . , B_{G}], where B_{G} is of dimension M_{T}×S_{g} and S_{g} is the number of users in group g. Given grouped users, it is possible to represent the channels as H=[H₁, . . . , H_{G}], where H_{g} (with dimension M_{T}×S_{g}) is a channel seen by users in group g and S_{g} is the number of users in group g. The effective channel matrix for group g after pre-beamforming with signals targeted to the same group of users is expressible as

\tilde{H}_{g,g}^{H}=H_{g}^{H}B_{g}. (4)

The second-stage precoding matrix may be designed based on the effective channel for the group \tilde{H}_{g,g} using zero-forcing (ZF) or regularized zero-forcing (RZF) precoding. The RZF precoding matrix is then expressible as

P_{g,g}=(\tilde{H}_{g,g}\tilde{H}_{g,g}^{H}+b_{g}αI_{b}_{_{g}})⁻¹\tilde{H}_{g,g}, (5)

where α is a regularization parameter which may be set to maximize the signal plus interference to noise ratio (SINR). As an illustrative example, α is arbitrarily chosen as

$$α = \frac{{\sum }_{g} {S}_{g}}{P {\sum }_{g} {b}_{g}} .$$

When applying P_{g,g,} the RZF precoding matrix is multiplied with a normalization of the factor ζ_{g}, where

$${ζ}_{g}^{2} = \frac{{S}_{g}}{tr ( {P}_{g , g}^{H} {B}_{g}^{H} {B}_{g} {P}_{g , g} )} .$$

For zero-forcing beamforming, the ZF precoding matrix is expressible as

P_{g,g}^{(zf)}=\tilde{H}_{g,g}(\tilde{H}_{g,g}^{H}\tilde{H}_{g,g})⁻¹. (6)

Therefore, the user has to feedback the effective channel \tilde{H}_{g,g}. With decoupled per group processing, the user feedback overhead and the computational complexity at the transmitter side are significantly reduced since the amount of feedback (the feedback of pre-beamformed channel for each group as opposed to feedback of the channel for the entire transmit antenna array) is decreased due to the decrease in the dimension of the effective channel, i.e., from M_{T} transmit antennas down to b_{g} virtual transmit antennas, where b_{g}<M_{T}. The pre-beamforming matrices {B_{g}} are designed using the composite channel covariance matrices of the groups that are formed based on transmit covariance matrices for the users in the same group. In order to obtain B_{g}, block diagonalization is performed by projecting the statistical channel of group g to the orthogonal subspace of statistical channels of all other groups. With block diagonalization, the pre-beamforming matrix B_{g} is orthogonal among groups, and the interference among transmitted signals for different user groups is then minimized.

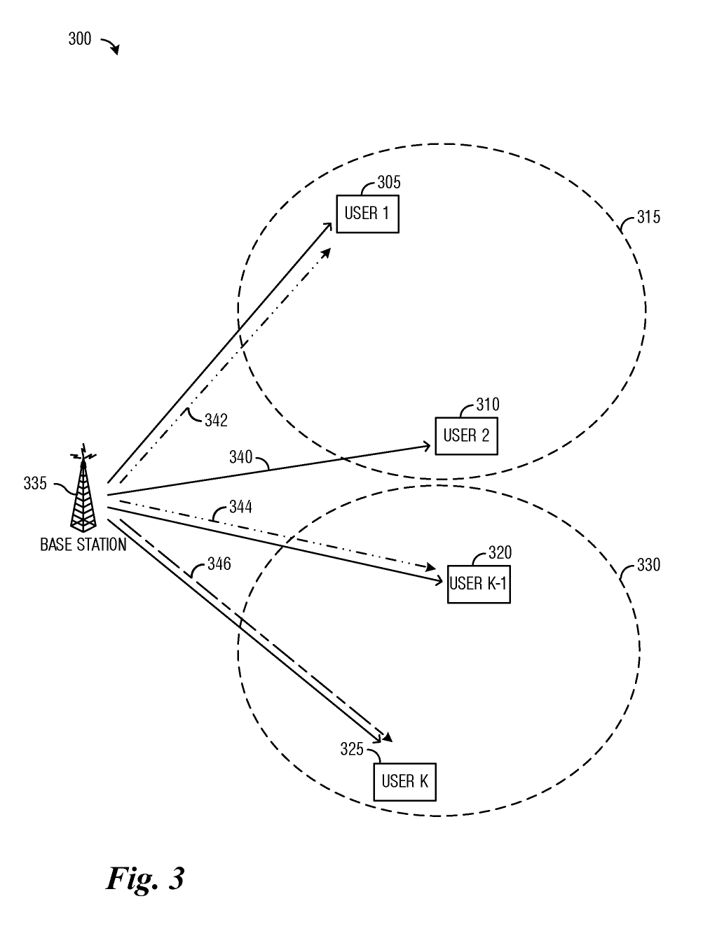

However, interference exists in the form of intra-group interference and inter-group interference. FIG. 3 illustrates a portion of an example communications system 300 highlighting interference. Communications system 300 includes a user 1 305 and a user 2 310 that are members of a first group 315 and a user K-1 320 and a user K 325 that are members of a second group 330. Communications system 300 also includes a base station 335 that is serving the users. Communications system 300 may also include other users and groups, but they are not shown to simplify the figure. Transmissions from base station 335 to a user may cause interference to other users, especially when the users are in relatively close proximity to each other. As an illustrative example, a transmission 340 from base station 335 to user 2 310 may also cause interference to user 1 305 (shown as interference transmission 342) and user K-1 320 (shown as interference transmission 344). Transmission 340 may also interfere with user K 325 (shown as interference transmission 346), but the interference cause to user K 325 may be sufficiently low that it may be ignored. Transmissions from base station 335 to other users (such as user 1 305, user K-1 320, and user K 325) may also cause interference to other users, but are not shown in FIG. 3 in order to maintain simplicity. Additionally, transmissions from the users to base station 335 may cause interference to other users in communications system 300, especially when the users are in relatively close proximity.

The interference may be classified as either intra-group interference or inter-group interference. As an illustrative example, transmission 342 may be classified as intra-group interference since user 1 305 and user 2 310 belong to the same group, while transmission 344 may be classified as inter-group interference since user 2 310 and user K-1 320 belong to different groups. It may be possible to also cause inter-group interference to user K 325.

In general, the inter-group interference channel from pre-beamformed signal for a g′-th group to a g-th group of users is expressible as

\tilde{H}_{g,g′}=H_{g}^{H}B_{g′}, g′=1, . . . , G, g′≠g. (7)

The SINR for the gₖ-th user, i.e., the k-th user in the g-th group, is expressible as

$${γ}_{{g}_{k}} = \frac{{ρζ}_{g}^{2} {\vert {h}_{{g}_{k}}^{H} {B}_{g} {P}_{g} ( \text{:} , k ) \vert}^{2}}{1 + {I}_{intra , {g}_{k}} + {I}_{inter , {g}_{k}}} , \\ {I}_{intra , {g}_{k}} = {ρζ}_{g}^{2} {\sum }_{j \neq k} {\vert {h}_{{g}_{k}}^{H} {B}_{g} {P}_{g} ( \text{:} , j ) \vert}^{2} , \\ {I}_{inter , {g}_{k}} = ρ {\sum }_{g ′ \neq g} {ζ}_{g}^{2} , {\sum }_{j} {\vert {h}_{{g}_{k}}^{H} {B}_{{g}^{′}} {P}_{{g}^{′}} ( \text{:} , j ) \vert}^{2} , \qquad ( 8 )$$

where I_{intra,g}_{ₖ} and I_{inter,g}_{ₖ} denote the intra-group interference and inter-group interference to user gₖ, respectively, h_{g}_{ₖ} is the channel vector of user gₖ, i.e., the k-th column of H_{g}, P_{g} (: , k) denotes the k-th column of precoding matrix P_{g}, and ρ denotes the average power per stream given as

$$ρ = \frac{P}{{\sum }_{g} {S}_{g}} . \qquad ( 9 )$$

The rate of user gₖ is expressible as

η_{g}_{ₖ}=log(1+γ_{d}_{ₖ}). (10)

According to an example embodiment, inter-group interference is considered when designing precoding matrices. The aforementioned two-stage precoding technique does not assume knowledge of the inter-group interference channel at the base station when obtaining the per group precoding. Although the inter-group interference is small when the users of a group are at or close to the center of the group, the transmit covariance of the users in one group may have large non-zero projections to the eigenvectors of the pre-beamforming matrix of another group.

For discussion purposes, consider a situation wherein the grouping of users are performed based on the channel covariance R_{g}_{ₖ} of the users. The pre-beamforming matrices are obtained using a particular method, such as eigen decomposition, approximate block diagonalization, discrete Fourier transform (DFT) approximation, and the like.

In order to obtain user feedback, a pre-beamformed pilot signal (i.e., B_{g}(:m)sₘ for m=1, . . . ,b_{g}) is made orthogonal with respect to other pre-beamformed pilot signals (by spreading with orthogonal codes, for example) and sent in time-frequency resources, where sₘ is the pilot symbol. The users then estimate the channel based on measurements of the received pre-beamformed pilot signal, e.g.,

y_{g}_{ₖ}ₘ=h_{g}_{ₖ}^{H}B_{g}(:, m)sₘ+n (11)

The estimated effective channel is h_{g}_{ₖ}^{H}B_{g}(:,m). With the transmission of pilots m=1, . . . , b_{g}, the user in group g may be able to estimate the effective pre-beamforming channel for its own group based on the pre-beamformed pilot signal associated with its own group and provide the channel feedback. The network (e.g., a base station or some other network entity) may signal the time-frequency resources used to send the pilot to the users, so the users will be able to measure the pilot and send the associated channel feedback. The network only needs to inform the pilots of the particular group. In other words, only the users of the particular group need to be informed regarding the time-frequency resources used to send the pilot associated with the particular group.

If the user is configured to feedback the channel for all pre-beamformed pilots for all groups, the composite channel H^{H}B may be obtained at the base station. Joint group precoding may be applied. However, this may significantly increase feedback complexity and increase signaling overhead for both the downlink (for signaling pilot symbols) and the uplink (for signaling channel feedback). Furthermore, it may not be necessary to feedback the complete channel information for all users if the pre-beamforming separates the users well in the spatial domain.

However, when a user is located at an edge of a coverage area of a group, the statistical channel of the user has non-negligible components projected onto the eigenspace of another group. Alternatively, a user may have multiple wide-spread clusters of a scattered ring. As an illustrative example, given the azimuth angle θ of a location of a user and an angle spread of a scatter ring, the correlation matrix R may be formed with the (i, j)-th entry [R]ᵢⱼ, which is expressible as

$${[ R ]}_{i , j} = \frac{1}{2 Δ} {\int }_{- Δ}^{Δ} {e}^{{jk}^{T} ( α + θ ) ( {u}_{i} + {u}_{j} )} d α , \qquad ( 12 )$$

where

$$k ( α ) = \frac{- 2 π}{λ} {( cos ( α ) , sin ( α ) )}^{T}$$

is the wave number vector for a planar wave with an angle of arrival α, λ is the carrier wavelength, uᵢ and uⱼ are the position vectors of antenna i and j, respectively, and (.)^{T} denotes the matrix transpose operator. If the distance between a user and the base station is s, and a radius of the scatter ring is r, then an angle spread may be approximated as

$$Δ \approx arctan ( \frac{r}{s} ) . \qquad ( 13 )$$

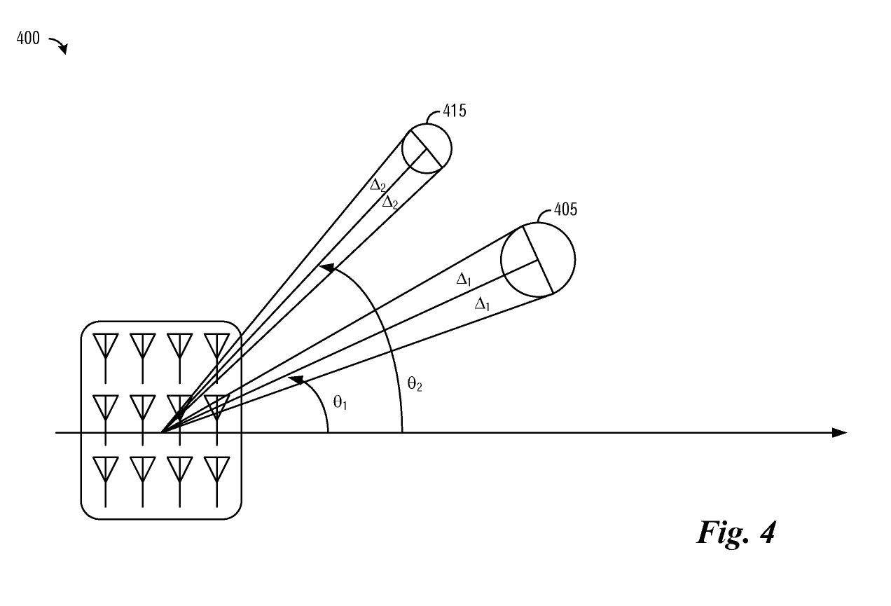

In general, a user may have two or more major clusters of scatter rings. FIG. 4 illustrates a diagram 400 highlighting two clusters of scatter rings. As shown in FIG. 4, a first scatter ring 405 is defined by (θ₁, Δ₁) and a second scatter ring 415 is defined by (θ₂, Δ₂) with ratios ξ₁ land ξ₂, respectively, where ξ₁+ξ₂=1. Then, the correlation matrix R is expressible as

R=ξ₁R₁(θ₁, Δ₁)+ξ₂R₂(θ₂, Δ₂) (14)

where R₁(θ₁, Δ₁) is formed as discussed above. If ξ₁>ξ₂, the user may be determined to be in a group with the eigenspace of R₁(θ₁, Δ₁). Thus the group with the pre-beamforming matrix on the eigenspace of R₂(θ₂, Δ₂) will cause interference to the user. In practice, the channel of a user may contain multiple scatter rings. Thus, the statistical channel can be represented as

R=Σᵢ₌₁^{Lc}ξᵢRᵢ(θᵢ, Δᵢ)

where L_{c} denotes total number of resolvable scatter rings. Therefore, the user may experience strong interference from other groups if the pre-beamforming matrices for the other groups are formed based on statistical channels which have some overlaps with one or more of spatial scatter ring components of the user.

According to an example embodiment, in order to overcome such a problem, it is determined how many channel groups that a user needs to feedback. A baseline may be that the user has to send the channel feedback for its own group, i.e., h_{g}_{ₖ}^{H}B_{g}. Then, based on the channel statistics of the user, the network determines additional channels or inter-group interference channels, h_{g}_{ₖ}^{H}B_{g′}, g′≠g, that user gₖ needs to measure and feedback.

It may be possible to determine the user feedback based on the channel statistics of user gₖ, R_{g}_{ₖ}, and the composite statistics of user group \tilde{R}_{g}. By default, it is assumed that the user needs to feedback the channel state information of the effective channel of its own group. Metrics may be used to determine if additional feedback of the pre-beamformed channels of other groups are needed. Such metrics include:

### Distance Metric:

Generally, with eigen decomposition, the channel covariance metric R may be represented as

R=UΛU^{H}, (15)

where Λ is the r×r diagonal matrix with r nonzero eigenvalues as the diagonal entries, U is the M_{T}×r tall unitary matrix with the eigenvectors, and r is the rank of R.

Therefore, for user gₖ in group g with covariance matrix R_{g}_{ₖ}, it can be shown that R_{g}_{ₖ}=V_{g}Λ_{g}B_{g}^{H}. Given the eigenvectors of R_{g}_{ₖ}, U_{g}_{ₖ}, and that of \tilde{R}_{g′}, V_{g′}, g′≠g, the distance between U_{g}_{ₖ}, and V_{g′}, d(U_{g}_{ₖ}, V_{g′}) may be considered as input to determine if user gₖ needs to feedback the channel h_{g}_{ₖ}^{H}B_{g′}. As an illustrative example, a threshold may be set, which may be expressed as

d(U_{g}_{ₖ}, V_{g′})<d_{th,g′}. (16)

The threshold d_{th,g′}, may be dependent on R_{g′}. The threshold may also be dependent on the distance metric employed. Alternatively, a distance ratio may be considered, e.g.,

$${κ}_{d} ( {U}_{{g}_{k}} , {V}_{g} , {V}_{{g}^{′}} ) = \frac{d ( {U}_{{g}_{k}} , {V}_{g} )}{d ( {U}_{{g}_{k}} , {V}_{{g}^{′}} )} . \qquad ( 17 )$$

When κ_{d}(U_{g}_{ₖ}, V _{g}, V_{g′}) is greater than a certain threshold, i.e., κ_{d}(U_{g}_{ₖ}, V_{g}, V_{g′})>κ_{d-th,g′}, indicating that the user is close enough to the center of neighboring group(s) compared with its own group, the user may be configured to feedback the channel h_{g}_{ₖ}^{H}B_{g′}. For the distance between the dominant eigenvectors used above, the chordal distance may be

$${d}_{c} ( {U}_{{g}_{k}} , {V}_{{g}^{′}} ) = \frac{1}{\sqrt{2}} {‖ {U}_{{g}_{k}} {U}_{{g}_{k}}^{H} - {V}_{{g}^{′}} {V}_{{g}^{′}}^{H} ‖}_{F} \qquad ( 18 )$$

where ∥.∥_{F} denotes the Frobenius norm operation. Alternatively, the Fubini-Study (FS) distance, expressible as

d_{FS}(U_{g}_{ₖ}, V_{g′})=cos⁻¹(|det(U*_{g}_{ₖ}V_{g′})|) (19)

may also be considered.

### Weighted Likelihood Similarly Measure:

The weighted likelihood similarity measure (WLSM) between R_{g}_{ₖ} and V_{g′} is defined as

L(R_{g}_{ₖ}, V_{g′})=∥(U_{g}_{ₖ}Λ_{g}_{ₖ}^{1/2})^{H}V_{g′}∥_{F}. (20)

Therefore, if L(R_{g}_{ₖ}, V _{g′}) is greater than a threshold L_{th,g′}, i.e., L(R _{g}_{ₖ}, V _{g′})>L_{th,g′}, the network signals the user to send the channel feedback for group g′, i.e., h_{g}_{ₖ}B_{g′}. It may also be possible to define a ratio for feedback selection, i.e.,

$${κ}_{L} ( {U}_{{g}_{k}} , {V}_{g} , {V}_{{g}^{′}} ) = \frac{L ( {U}_{{g}_{k}} , {V}_{{g}^{′}} )}{L ( {U}_{{g}_{k}} , {V}_{g} )} . \qquad ( 21 )$$

Thus, if κ_{L} is greater than a threshold κ_{L}(U_{g}_{ₖ}, V_{g}, V_{g′}), the network configures the user to send the channel feedback for group g′, i.e., h_{g}_{ₖ}^{H}B_{g′}.

### Subspace Projection Similarity Measure:

The subspace projection similarity measure (SPSM) for the dominant eigenvectors is defined as

[symbol]

(U_{g}_{ₖ}, V_{g′})=∥V_{g′}V_{g′}^{H}U_{g}_{ₖ}−U_{g}_{ₖ}∥_{F}². (22)

A ratio for feedback selection is expressible as

$${κ}_{℘} ( {U}_{{g}_{k}} , {V}_{g} , {V}_{{g}^{′}} ) = \frac{℘ ( {U}_{{g}_{k}} , {V}_{g} )}{℘ ( {U}_{{g}_{k}} , {V}_{{g}^{′}} )} . \qquad ( 23 )$$

Criterions for user feedback selection include

[symbol]

(U_{g}_{ₖ}, V_{g′})< [symbol] _{th,g′} (24)

or

[symbol]

(U_{g}_{ₖ}, V_{g}, V_{g′})> [symbol] th,g′. (25)

As described above, a metric may be used in direct comparison with a threshold. Alternatively, a ratio of metrics comprising a user in a first group g and the user in a second group g′ may be used. Joint consideration of both conditions may be used to determine the user feedback of group g′. The decision may be a logical OR or a logical AND operation of the two conditions, for example.

In practice, a maximum number of users sending the feedback of the pre-beamformed channels for other groups may be set, as well as a maximum number of channel groups for which a user sends the channel feedback. Denote K_{g} as a set of users in group g that sends the inter-group channel information and g_{g}_{ₖ} as the set of group that user gₖ sends the channel feedback. It is assumed that g∈g_{g}_{ₖ}. In such a situation, the network needs to order the metrics or the ratios to determine which user and what channel group for the channel feedback. As an example, if |K_{g}|≦1 and |g_{g}|<2, it means that for group g, at most one user is requested to send the channel feedback for at most one additional grouped channel. It is noted that feedback of the user's own channel group is required by default here although it may not be necessary by default.

If the user sends feedback for all of the pre-beamformed channel groups, the channel at the transmitter side is expressible as

$${\tilde{H}}^{H} = [ \begin{matrix}{H}_{1}^{H} {B}_{1} & {H}_{1}^{H} {B}_{2} & ⋯ & {H}_{1}^{H} {B}_{G} \\ {H}_{2}^{H} {B}_{1} & {H}_{2}^{H} {B}_{2} & ⋯ & {H}_{2}^{H} {B}_{G} \\ ⋮ & ⋮ & ⋱ & ⋮ \\ {H}_{G}^{H} {B}_{1} & {H}_{G}^{H} {B}_{2} & ⋯ & {H}_{G}^{H} {B}_{G}\end{matrix} ] = [ \begin{matrix}{\tilde{H}}_{1}^{H} {B}_{1} & {\tilde{H}}_{1}^{H} {B}_{2} & ⋯ & {\tilde{H}}_{1}^{H} {B}_{G} \\ {\tilde{H}}_{2}^{H} {B}_{1} & {\tilde{H}}_{2}^{H} {B}_{2} & ⋯ & {\tilde{H}}_{2}^{H} {B}_{G} \\ ⋮ & ⋮ & ⋱ & ⋮ \\ {\tilde{H}}_{G}^{H} {B}_{1} & {\tilde{H}}_{G}^{H} {B}_{2} & ⋯ & {\tilde{H}}_{G}^{H} {B}_{G}\end{matrix} ] , \qquad ( 26 )$$

where \tilde{H}_{g,g′} [symbol] B_{g′}^{H}H_{g}. The joint precoding may be performed based on \tilde{H}^{H}. In order to reduce the feedback overhead, with nicely designed pre-beamforming matrices {B_{g}}, a user sends only feedback for the channel for its own group, i.e., for user gₖ belonging to group g, only the channel h_{g}_{ₖ}^{H}B_{g′} is feedback. The channel state information (CSI) at the base station is then expressible as

$${\tilde{H}}_{PGP}^{H} = [ \begin{matrix}{H}_{1}^{H} {B}_{1} & 0 & ⋯ & 0 \\ 0 & {H}_{2}^{H} {B}_{2} & ⋯ & 0 \\ ⋮ & ⋮ & ⋱ & ⋮ \\ 0 & 0 & ⋯ & {H}_{G}^{H} {B}_{G}\end{matrix} ] = [ \begin{matrix}{\tilde{H}}_{1 , 1}^{H} & 0 & ⋯ & 0 \\ 0 & {\tilde{H}}_{2 , 2}^{H} & ⋯ & 0 \\ ⋮ & ⋮ & ⋱ & ⋮ \\ 0 & 0 & ⋯ & {\tilde{H}}_{G , G}^{H}\end{matrix} ] . \qquad ( 27 )$$

The inter-group interference channel information ({H_{g}^{H}B_{g′}, g≠g′}) is not available at the base station since the CSI reported to the base station contains zero terms for the off-diagonal elements. Hence, the precoding for the group is obtained based only on the channel H_{g}^{H}B_{g} only and the precoder design may be decoupled as per-group processing.

Due to the dynamic nature of users, some user may experience strong interference from signaling to users in another group, which may be justified based on the pre-beamforming matrices {B_{g}} and the channel statistics of the user, e.g., the transmit channel covariance, R_{g}_{ₖ}. Based on the discussion presented previously, the composite channel may be derived, which may be expressed as

$${\tilde{H}}_{ePGP}^{H} = [ \begin{matrix}{\tilde{H}}_{1 , 1}^{H} & {\tilde{H}}_{1 , 2}^{H} ( \text{:} , {\tilde{𝒰}}_{1 , 2} ) & ⋯ & {\tilde{H}}_{1 , G}^{H} ( \text{:} , {\tilde{𝒰}}_{1 , G} ) \\ {\tilde{H}}_{2 , 1}^{H} ( \text{:} , {\tilde{𝒰}}_{2 , 1} ) & {\tilde{H}}_{2 , 2}^{H} & ⋯ & {\tilde{H}}_{2 , G}^{H} ( \text{:} , {\tilde{𝒰}}_{2 , G} ) \\ ⋮ & ⋮ & ⋱ & ⋮ \\ {\tilde{H}}_{G , 1}^{H} ( \text{:} , {\tilde{𝒰}}_{G , 1} ) & {\tilde{H}}_{G , 2}^{H} ( \text{:} , {\tilde{𝒰}}_{G , 2} ) & ⋯ & {\tilde{H}}_{G , G}^{H}\end{matrix} ] , \qquad ( 28 )$$

where Ũ_{g,g′} denotes the set of users (or column indices) in group g sending channel feedback of the channel group g′, i.e., for the user in group g to feedback the k-th column of \tilde{H}_{g,g′}, assuming the order of the channel matrix \tilde{H}_{g,g′} is in the increasing order of k.

If Ũ_{g,g′} is the full set of all users in group g for any g, g′, the effective channel matrix \tilde{H}_{ePGP}^{H} becomes \tilde{H}^{H}. If Ũ_{g,g′} is an empty set for any g, g′, g′≠g the effective channel marix \tilde{H}_{ePGP}^{H} becomes \tilde{H}_{PGP}^{H}. With the network configuring users to provide user specific channel group feedback, the effective channel matrix is in between \tilde{H}^{H} and \tilde{H}_{PGP}^{H}. Cases where the cardinality of Ũ_{g,g′}, g′≠g, is small, e.g., Ũ_{g,g′≦}1 or 2 and most of Ũ_{g,g′} are empty sets.

Given \tilde{H}_{ePGP}, it may be possible to consider joint precoding based on \tilde{H}_{ePGP} directly, i.e.,

P_{ePGP,JP}=(\tilde{H}_{ePGP}\tilde{H}_{ePGP}^{H}+bαI)⁻¹\tilde{H}_{ePGP}^{H}, (29)

where b=Σ_{g}b_{g}. The normalization factor is then expressible as

$${ζ}_{ePGP , JP}^{2} = \frac{S}{tr ( {P}_{ePGP , JP}^{H} {B}^{H} {BP}_{ePGP , JP} )} . \qquad ( 30 )$$

With inter-group channel feedback, it is possible to perform precoding with per-group processing to reduce the complexity at the expense of non-optimal precoding matrices. The effective channel for pre-beamformed pilots B_{g} may be formed for all users that provide channel feedback as

$${\tilde{H}}_{ePGP , g}^{H} = [ \begin{matrix}{\tilde{H}}_{1 , g}^{H} ( \text{:} , {\tilde{𝒰}}_{1 , g} ) \\ {\tilde{H}}_{2 , g}^{H} ( \text{:} , {\tilde{𝒰}}_{2 , g} ) \\ ⋮ \\ {\tilde{H}}_{G , g}^{H} ( \text{:} , {\tilde{𝒰}}_{G , g} )\end{matrix} ] , \qquad ( 31 )$$

where Ũ_{g,g} is the full user set for group g. The precoding may be formed for all users in ∪_{g′} Ũ_{g′,g}, which may be expressible as

P_{ePGP,g}=(\tilde{H}_{ePGP,g}\tilde{H}_{ePGP,g}+bαI)⁻¹\tilde{H}_{ePGP,g}^{H}. (32)

For per-group precoding with inter-group channel feedback, it is possible to form a simple normalization factor for the precoding, expressible as

$${ζ}_{ePGP , g}^{2} = \frac{{S}_{ePGP , g}}{tr ( {P}_{ePGP , g}^{H} {B}_{g}^{H} {B}_{g} {P}_{ePGP , g} )} , \qquad ( 33 )$$

where

S_{ePGP,g}=|∪_{g′}Ũ_{g,g′|} (34)

and |.| denotes the cardinality of the set. In the approach presented above, the user in group g′, i.e., g′ₖ, with the channel feedback for group g is treated as a virtual user in group g and the precoding vector is formed for this user in group g. Therefore, the entire precoding vector for user gₖ is the precoding vector in all the groups to which the user sends, i.e.,

p_{ePGP,g}_{ₖ}=[P_{ePGP,g1}(:, [symbol] _{g}_{ₖ}_{,1})^{T}, P_{ePGP,2}(:, [symbol] _{g}_{ₖ}_{,2}^{T}, . . . , P_{ePGP,G}(:, [symbol] _{g}_{ₖ} _{,G})^{T}]^{T}, (35)

where [symbol] _{g}_{ₖ}_{,g′} is either the empty set or a one element set that contains the column index of a precoding matrix of group g′ for user gₖ. If [symbol] _{g}_{ₖ}_{,g′} is an empty set, the precoding vector P_{ePGP,g′}(:, [symbol] _{g}_{ₖ}_{,1})^{T} will be a zero vector. For discussion purposes, the power normalization factor matrix is expressed as

A_{ePGP,g}_{ₖ} [symbol] diag{ζ_{ePGP,1}1_{b}_{₁}^{T}, ζ_{ePGP,2}1_{b}_{₂}^{T}, . . . , ζ_{ePGP,G}1_{b}_{_{G}}^{T}}, (36)

where 1_{b}_{_{g}} denotes an all-one vector of dimension b_{g}. The first-stage precoding vector for user gₖ with normalization is expressible as

\tilde{P}_{ePGP,g}_{ₖ}=A_{ePGP,g}_{ₖ}P_{eGPG,g}_{ₖ}. (37)

The overall precoding vector for user gₖ is then expressible as

v_{g}_{ₖ}=B\tilde{p}_{ePGP,g}_{ₖ}. (38)

Therefore, the necessary conditions for performing per-group precoding (i.e., the number of users including the virtual users in a group shall be smaller than the number of effective transmit pilots and/or streams in the group) are expressible as

S_{ePGP,g}=|∪_{g′}Ũ_{g,g′}|≦b_{g}, g=1, . . . , G. (39)

The SINR is then expressible as

$${γ}_{ePGP , {g}_{k}} = \frac{ρ {\sum }_{{g}^{′}} {ζ}_{ePGP , {g}^{′}}^{2} {\vert {h}_{{g}_{k}}^{H} {B}_{{g}^{′}} {P}_{{g}^{′}} ( \text{:} , {ℶ}_{{g}_{k} , {g}^{′}} ) \vert}^{2}}{1 + ρ {\sum }_{{g}^{′} , {g}^{″}} {\sum }_{j , {g}^{″} j \neq {g}_{k}} {ζ}_{ePGP , {g}^{′}}^{2} {\vert {h}_{{g}_{k}}^{H} {B}_{{g}^{′}} {P}_{{g}^{′}} ( \text{:} , {ℶ}_{{g}_{j}^{″} , {g}^{′}} ) \vert}^{2}} . \qquad ( 40 )$$

The rate is expressible as

η_{ePGP,g}=log)1+γ_{ePGP,g}_{ₖ}). (41)

Since virtual users are included, the total number of users including the virtual users is more than the actual number of users. The power per virtual stream may be scaled as

$$ρ = \frac{P}{\sum {S}_{ePGP , g}} . \qquad ( 42 )$$

The regularization factor may be changed to

$$α = \frac{{\sum }_{g} {S}_{g}}{{\sum }_{g} tr ( {P}_{ePGP , g}^{H} {B}_{g}^{H} {B}_{g} {P}_{ePGP , g} )}$$

accordingly although it may not be necessary to do so since the precoding performed above is not an optimal solution. To overcome the non-optimality, global normalization may be performed although the precoding is still performed on a per-group basis. The global normalization is expressible as

$${ζ}_{ePGPglobal}^{2} = \frac{{\sum }_{g} {S}_{g}}{{\sum }_{g} tr ( {P}_{ePGP , g}^{H} {B}_{g}^{H} {B}_{g} {P}_{ePGP , g} )} . \qquad ( 43 )$$

The final precoding vector is expressible as

\tilde{p}_{ePGP,g}_{ₖ}=ζ_{ePGP}_{_{global}}p_{ePGP,g}_{ₖ}. (44)

An alternative approach to power normalization is as follows. A power splitting factor is expressed as

a_{g}_{ₖ} [symbol] [a_{g}_{ₖ}_{,1}, a_{g}_{ₖ}_{,2}, . . . , a_{g}_{ₖ}_{,G}]^{T}, (45)

where a_{g}_{ₖ}_{,g′}, g′=1, . . . , G is the split power scaling factor for user gₖ in group g′, and Σ_{g′}a_{g}_{ₖ}_{,g}=1 or in vector form a_{g}_{ₖ}^{T}1 =1. If there is a precoding vector formed for user gₖ in group g′, the scaling factor a_{g}_{ₖ}_{,g′} is then a non-zero component. In a situation with per-group processing without inter-group channel feedback, a_{g}_{ₖ}_{,g′}=0 for g′≠g and a_{g}_{ₖ}_{,g}=1. It is noted that the power splitting presented herein involves the splitting of the power based on a user's channel, and consequently, the precoding vector and precoding normalization.

### Method 1:

With the scaling vector a_{g}_{ₖ} formed for every user, it is possible to form the precoding matrix for group g in a manner as discussed above with the normalization factor for group g expressed as

$${ζ}_{ePGP , g}^{2} = \frac{{S}_{ePGP , g}}{tr ( {P}_{ePGP , g}^{H} {B}_{g}^{H} {B}_{g} {P}_{ePGP , g} )} ,$$

as expressed above and with S_{ePGP,g} being expressed as

S_{ePGP,g}=Σ_{g′,k}a_{g′}_{ₖ}_{,g} (46)

rather than as before. The final precoding vector is expressed as \tilde{p}_{ePGP,g}_{ₖ}=A_{ePGP,g}_{ₖ}p_{ePGP,g}_{ₖ}.

### Method 2:

An alternative way to incorporate the splitting scaling factors involves a scaling of the channel, which is expressible as

$$= {\tilde{H}}_{{g }^{′} , g} diag \{ \sqrt{{a}_{{g}_{1}^{′} , g} ,} … , \sqrt{{a}_{{g}_{{s}_{{g }^{′}}}^{′} , g}} \} . \qquad ( 47 )$$

### Then

$$= [ \begin{matrix} ( \text{:} , {\tilde{𝒰}}_{1 , g} ) \\ ( \text{:} , {\tilde{𝒰}}_{2 , g} ) \\ ⋮ \\ ( \text{:} , {\tilde{𝒰}}_{G , g} )\end{matrix} ] . \qquad ( 48 )$$

The precoding matrix is expressible as

P′_{ePGP,g}=(\tilde{H}′_{ePGP,g}\tilde{H}′_{ePGP,g}^{H}+b_{g}αI)⁻¹\tilde{H}′_{ePGP,g}. (49)

The power normalization for the precoding is expressible as

$${ζ}_{ePGP , g}^{′2} = \frac{{\sum }_{k , {g}^{′}} {a}_{{g}_{k}^{′} , g}}{tr ( {P}_{ePGP , g}^{′H} {B}_{g}^{H} {B}_{g} {P}_{ePGP , g}^{′} )} . \qquad ( 50 )$$

### Method 3:

Scaling may also be applied directly to P_{ePGP,g} with \sqrt{a_{g′}_{ₖ}_{,g}} for the users with the channel feedback for group g, which is expressible as

$${P}_{ePGP , g}^{∤} = {P}_{ePGP , g} diag \{ \{ \sqrt{{a}_{{g}_{k}^{′} , g}} {\vert}_{{g}_{k}^{′}} ∈ {\tilde{𝒰}}_{{g}^{′} , g} , {g}^{′} = 1 , … , G \} \} . \qquad ( 51 )$$

The normalization factor is expressible as

$${ζ}_{ePGP , g}^{∤ 2} = \frac{{\sum }_{{k , {g}^{′} ⌋}_{{g}_{k}^{′}} ∈ {\tilde{𝒰}}_{{g}^{′} , g} , {g}^{′} = 1 , … , G} {a}_{{g}_{k}^{′} , g}}{tr ( {P}_{ePGP , g}^{{V}^{H}} {B}_{g}^{H} {B}_{g} {P}_{ePGP , g}^{∤} )} . \qquad ( 52 )$$

A special case of Method 3 described above involves the setting of a_{g′}_{ₖ}_{,g′}=1 and a_{g′}_{ₖ}_{,g}=0 for g′≠g for user g′ₖ, i.e., for any user with inter-group channel feedback, all power is allocated to the precoding component in its own group and no power is allocated to the stream on the inter-group precoding. This is followed with power scaling and power normalization. It is noted that this variation differs from per-group precoding without inter-group channel feedback because the precoding for group g considers the users in other groups (g′≠g) with the inter-group channel feedback for group g where the precoding is performed. By setting a_{g′}_{ₖ}_{,g}=0 for g′≠g, the precoding vectors for users from other groups are discarded. The power normalization is performed for the precoding vectors of the users within the group. The inter-group channel feedback from the users in the other groups is just for the users in the current group to avoid the interference from the users in the other groups. This variant may be advantageous since it is usually difficult to find the optimal power scaling or splitting factors for a user with inter-group channel feedback. Therefore, the precoding with inter-group interference avoidance is a robust approach.

It is possible to obtain a_{g}_{ₖ}_{,g′} for user gₖ by considering a simple approach that is based on the user channel feedback. If a user is configured to send only channel feedback for its own group, a_{g}_{ₖ}_{,g}=1 and a_{g}_{ₖ}_{,g′}=0 for all g′≠g. If the user has inter-group channel feedback, then

$${a}_{{g}_{k} , {g}^{′}} = \frac{{‖ {h}_{{g}_{k}}^{H} {B}_{{g}^{′}} ‖}^{2}}{{\sum }_{{g}^{∤} ∈ {ℊ}_{{g}_{k}}} {‖ {h}_{{g}_{k}}^{H} {B}_{{g}^{∤}} ‖}^{2}} . \qquad ( 53 )$$

For the Method 3 discussed previously, the power splitting may be obtained directly from the precoding vectors in each group for a particular user. Given the p_{ePGP,g}_{ₖ},

$${a}_{{g}_{k} , {g}^{′}} = \frac{{‖ {P}_{ePGP , {g}^{′}} ( \text{:} , {ℶ}_{{g}_{k} , {g}^{′}} ) ‖}^{2}}{{\sum }_{{g}^{∤}} {‖ {P}_{ePGP , {g}^{′}} ( \text{:} , {ℶ}_{{g}_{k} , {g}^{∤}} ) ‖}^{2}} . \qquad ( 54 )$$

Assuming a linear antenna array, it is possible to express the downlink channel and the uplink channel of a communications system as

$$\begin{matrix}{v}_{D} ( θ ) = {[ 1 , {e}^{- j \frac{2 π}{{λ}_{D}} dsin ( θ )} , … , {e}^{- j \frac{2 π}{{λ}_{D}} {M}_{T} dsin ( θ )} ]}^{T} & ( 55 ) \\ {v}_{U} ( θ ) = {[ 1 , {e}^{- j \frac{2 π}{{λ}_{U}} dsin ( θ )} , … , {e}^{- j \frac{2 π}{{λ}_{U}} {M}_{T} dsin ( θ )} ]}^{T} , & ( 56 )\end{matrix}$$

respectively, where d is the antenna spacing. A transformation matrix is expressed as

$$T ( θ ) = diag \{ 1 , {e}^{- j 2 π ( \frac{1}{{λ}_{D}} - \frac{1}{{λ}_{U}} ) dsin ( θ )} , … , {e}^{- j 2 π ( \frac{1}{{λ}_{D}} - \frac{1}{{λ}_{U}} ) {M}_{T} dsin ( θ )} \} , \qquad ( 57 )$$

so that

v_{D}(θ)=T(θ)v_{U}(θ). (58)

The channel correlation matrices at the base station are expressible as

R_{D}=∫_{θ}p_{D}(θ)v_{D}(θ)v_{D}^{H}(θ)dθ, (59)

and

R_{U}=∫_{θ}p_{U}(θ)v_{U}(θ)v_{U}^{H}(θ)dθ, (60)

where p_{D}(θ) and p_{U}(θ) are the path power densities for the downlink and uplink channels for the angle θ. Generally, the pathloss for the uplink and downlink channels are the same for the same angle of arrival, i.e.,

p_{D}(θ)≈p_{U}(θ) (61)

Then,

R_{D}≈∫_{θ}p_{U}(θ)T(θ)v_{U}(θ)v_{U}^{H}(θ)T^{H}(θ)dθ. (62)

A simple technique to determine the transmit correlation from the uplink receive correlation is to first find the most dominant angle of arrival θ*. The estimate of the downlink transmit covariance matrix is expressible as

\hat{R}_{D}≈T(θ*)R_{U}T^{H}(θ*). (63)

Alternatively, based on sampled directions of arrival {θ_{i}}

\hat{R}_{D}≈Σ_{θ}_{ᵢ}P_{U}(θᵢ)T(θᵢ)v_{U}(θᵢ)v_{U}^{H}(θᵢ)T^{H}(θᵢ), (64)

where {θᵢ} are resolvable directions of arrival and P_{U}(θᵢ) is the power of θᵢ.Hence, based on above discussed procedures, the downlink statistical channel information, e.g., the downlink transmit correlation matrix, may be obtained from the uplink channel measurement for FDD systems.

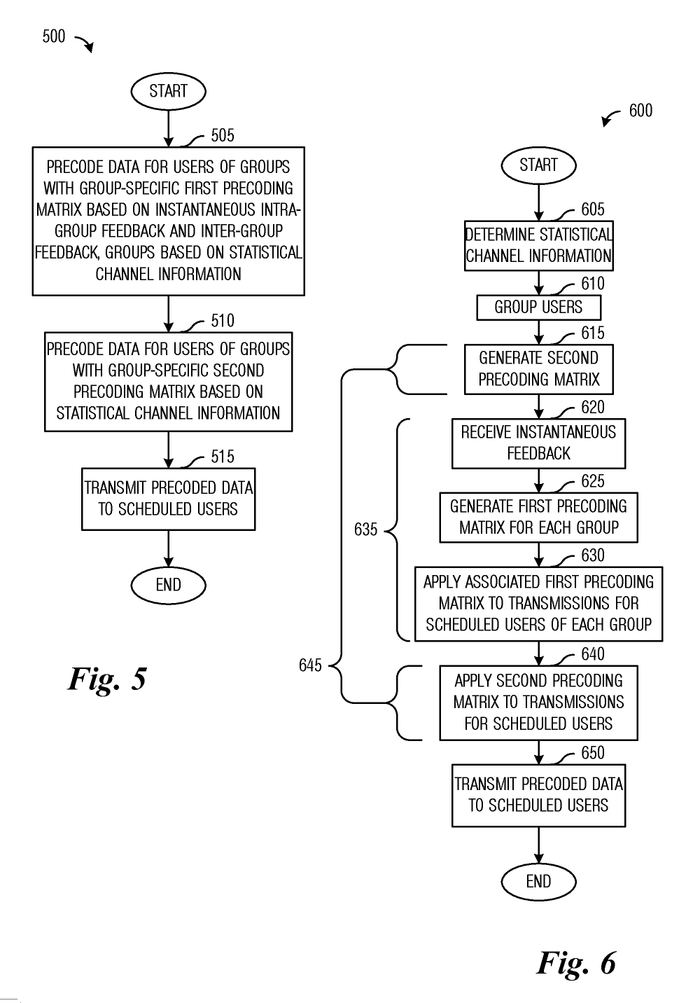

FIG. 5 illustrates a flow diagram of example high-level operations 500 occurring in a transmitting device using two-stage precoding with intra-group and inter-group feedback. Operations 500 may be indicative of high-level operations occurring in a transmitting device, such as a base station or a user, as the transmitting device uses two-stage precoding with intra-group and inter-group feedback.

Operations 500 begin with the transmitting device precoding data for users of groups with group-specific first precoding matrices designed in accordance with instantaneous intra-group feedback and inter-group channel feedback, thereby producing first precoded data (block 505). The users of different groups are precoded with different group-specific first precoding matrices. The different group-specific first precoding matrices are designed based on instantaneous intra-group feedback information and inter-group feedback information provided by the users of the groups. The users are grouped based on statistical channel information, which may be obtained from user feedback provided by the users or based on uplink measurements (for example, using channel reciprocity as described previously). An example of the group-specific first precoding matrix is the P precoding matrix discussed previously. The precoding with the group-specific first precoding matrices may be referred to as first stage precoding. The transmitting device precodes the first precoded data with group-specific second precoding matrices designed in accordance with statistical channel information, thereby producing second precoded data (block 510). The users may be grouped based on statistical channel information, which may be obtained from user feedback provided by the users or based on uplink measurements. The precoding with the group-specific second precoding matrices may be referred to as second stage precoding. An example of the group-specific second precoding matrix is the B precoding matrix discussed previously. The transmitting device transmits the second precoded data to scheduled users (block 515).

FIG. 6 illustrates a flow diagram of first example operations 600 occurring in a transmitting device using two-stage precoding with intra-group and inter-group feedback. Operations 600 may be indicative of operations occurring in a transmitting device, such as a base station or a user, as the transmitting device uses two-stage precoding with intra-group and inter-group feedback.

Operations 600 begin with the transmitting device determining statistical channel information (block 605). The statistical channel information may be determined from feedback received from the users or uplink measurements made by the transmitting device. The transmitting device groups the users (block 610). The grouping of the users into different groups also includes the determination of user feedback groups (the determination of which users in groups report intra-group feedback and inter-group feedback). The determination of the users for intra-group feedback and/or inter-group feedback may be based on the statistical channel information received by the transmitting device or from uplink measurements made by the transmitting device.

The transmitting device may group the users based on the channel condition, for example, which may be determined from the user feedback or the uplink measurements. The transmitting device generates a second precoding matrix for each group (block 615). The second precoding matrices may be generated in accordance with the statistical channel information. The second precoding matrices may be generated prior to the generation of the first precoding matrices due to the fact that the second precoding matrices are used to precode pilot signals transmitted by the transmitting device to permit the users to measure and provide instantaneous channel feedback to the transmitting device, which are used to generate the first precoding matrices, for example. The transmitting device receives instantaneous channel feedback (block 620).

The instantaneous channel feedback may include the intra-group channel feedback and the inter-group channel feedback. The transmitting device generates a first precoding matrix for each group (block 625). The first precoding matrix may be generated in accordance with the instantaneous channel feedback received from the users. The transmitting device applies the first precoding matrix to data for scheduled users of each group (block 630). The application of the first precoding matrix to the data produces first precoded data. Collectively, blocks 620 (receiving instantaneous feedback), 625 (generating the first precoding matrix) and 630 (applying the first precoding matrix) may be referred to as precoding data for users of groups with group-specific first precoding matrices (blocks 635) and may be an example implementation of block 505 of FIG. 5. The transmitting device applies the second precoding matrix to the first precoded data (block 640). The application of the second precoding matrix to the first precoded data produces precoded data. Collectively, blocks 615 (generating the second precoding matrix) and 640 (applying the second precoding matrix) may be referred to as precoding data for users with second precoding matrices (blocks 645) and may be an example implementation of block 510 of FIG. 5. The transmitting device transmits the precoded data to the scheduled users (block 650).

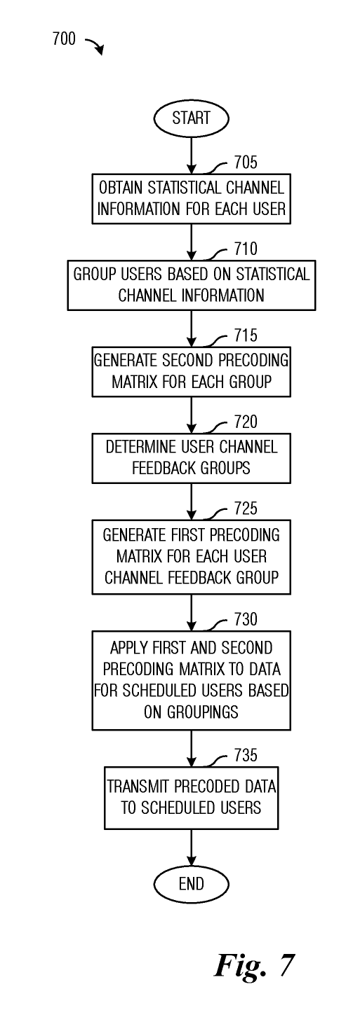

FIG. 7 illustrates a flow diagram of second example operations 700 occurring in a transmitting device using two-stage precoding with intra-group and inter-group feedback. Operations 700 may be indicative of operations occurring in a transmitting device, such as a base station or a user, as the transmitting device uses two-stage precoding with intra-group and inter-group feedback.

Operations 700 begin with the transmitting device obtaining statistical channel information for users (block 705). The statistical channel information may be determined from channel feedback received from the users. The statistical channel information may be determined from uplink channel measurements and adjustments based on uplink and downlink carrier spacing. The transmitting device forms user groups (block 710). The user groups are formed in accordance with the statistical channel information. The transmitting device generates a second precoding matrix for each group (block 715). The transmitting device determines if the users need to provide inter-group channel feedback and determines user channel feedback groups (block 720).

The determination of if the users need to provide inter-group channel feedback may be in accordance with the channel statistics and individual metric(s) or measure(s) of the users. As an illustrative example, the individual metric(s) or measure(s) are distance metrics, such as chordal distance or FS distance or some other similarity measure (e.g., a weighted likelihood similarity measure or a subspace projection similarity measure). Inter-group channel feedback selection may be determined by a threshold on distance or similarity or on a ratio of distances or measures. As an illustrative example, if the distance between the eigenspace of the statistical channel matrix and the eigenspace of the statistical channel matrix of a group which the user does not belong to is less than a threshold, then the user may be selected to provide inter-group channel feedback, i.e., providing the user channel feedback for the pre-beamformed matrix of the group which the user does not belong to. As another illustrative example, if a weighted likelihood similarity measure of the statistical channel matrix and the statistical channel matrix of a group which the user does not belong is within a threshold of each other, then the user may be selected to provide inter-group channel feedback.

The inter-group channel feedback may also be constrained by a limitation on the number of users in a group |K_{g}| and a number of groups for a user |g_{g}_{ₖ}| with inter-group channel feedback. As an illustrative example, although the distance between the statistical channel information of the user and the statistical channel information of the group is less than a threshold, if the respective groups already have users reporting inter-group channel feedback and the number of users exceed a number of users threshold, the user may not be selected to provide inter-group channel feedback. The transmitting device generates a first precoding matrix for each user channel feedback group (block 725). The transmitting device applies the first precoding matrix and the second precoding matrix to data for scheduled users based on the user groupings (block 730). The transmitting device transmits the precoded data to the scheduled users (block 735).

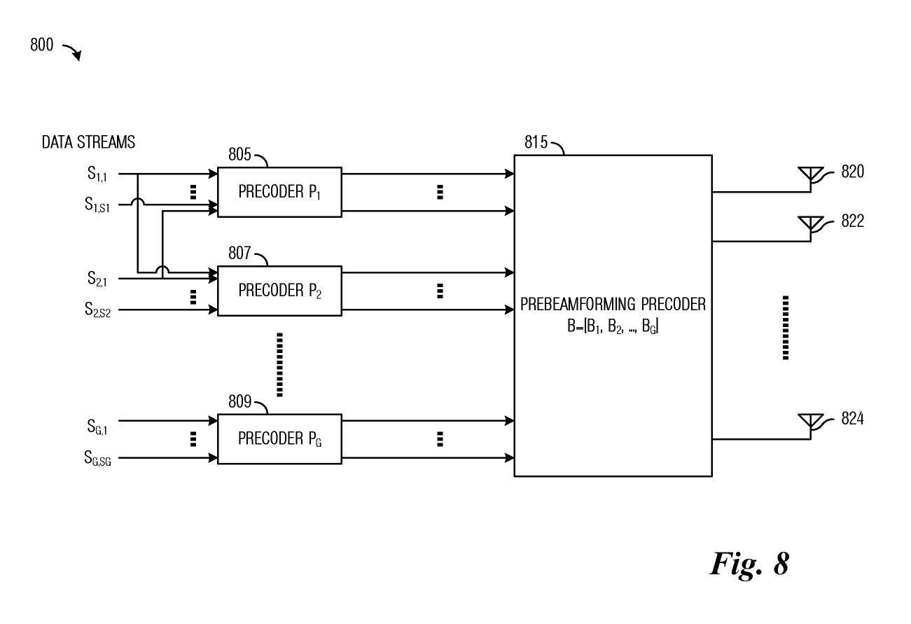

FIG. 8 illustrates an example processing unit 800 for two-stage precoding data streams with intra-group and inter-group feedback. Processing unit 800 includes a plurality of group-specific first precoders P, such as precoder P₁ 805, precoder P₂ 807, and precoder P_{G} 809, with one precoder for each user group. Each of the group-specific first precoders may have a plurality of input data streams, with one data stream per user in a user group. As an illustrative example, precoder P₁ 805 includes S₁ data streams (data streams S_{1,1} to S_{1,S}_{₁}), where S₁ is the number of users in user group 1. Similarly, precoder P_{G} 809 includes S_{G} data streams (data streams S_{G,1} to S_{G,S}_{_{G}}), where S_{G} is the number of users in user group G. In order to configure precoding with inter-group channel feedback as determined based on the statistical channel information of the users, a subset of the data streams associated with a particular user group is also provided as input to one or more other user groups. As shown in FIG. 8, for example, one or more data streams for user group 1 are also inputs to precoder P₂ 807, and vice versa. The configuration of the plurality of group-specific first precoders P, as shown in FIG. 8, implement an example precoding with inter-group channel feedback and is intended for discussion purposes only and other inter-group interaction configurations are possible. The plurality of group-specific first precoders applies the first-stage precoding matrices to the input data streams.

The outputs of the plurality of group-specific first precoders are inputs to pre-beamforming precoder 815. Pre-beamforming precoder 815 is configured to apply the pre-beamforming matrix to the user data which have already been precoded with the first-stage precoding matrices. Pre-beamforming precoder 815 may be an implementation of the B precoding matrix discussed previously. The outputs of the pre-beamforming precoder 815 are provided to antennas, such as antenna 820, 822, and 824, to transmit to the users.

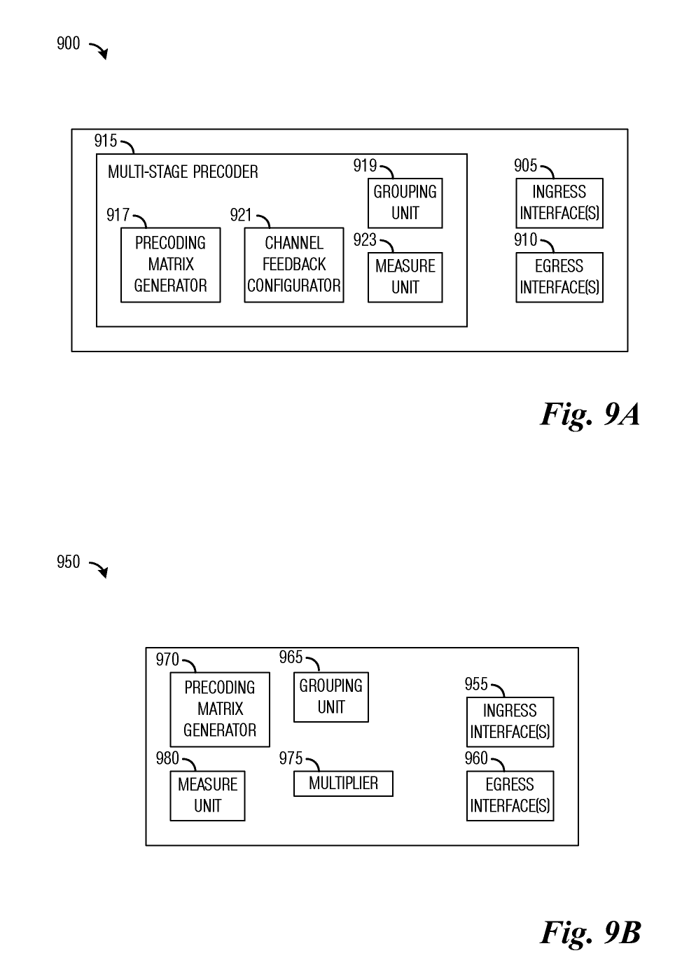

FIG. 9A illustrates a block diagram of a first embodiment transmitting device 900. Transmitting device 900 is adapted to precode an outgoing data stream in multiple stages. As shown in FIG. 9A, transmitting device 900 includes one or more ingress interfaces 905, one or more egress interfaces 910, and a multi-stage precoder 915. The one or more ingress interfaces 905 may be configured to receive information (e.g., instantaneous channel feedback, statistical channel information, etc.) from devices (e.g., receiving devices) in a wireless network, and the one or more egress interfaces 910 may be configured to send precoded data streams to devices (e.g., receiving devices) in the wireless network. Multi-stage precoder 915 may include hardware and/or software adapted to generate precoded data streams based at least in part on information received over the one or more ingress interfaces 905.

Multi-stage precoder 915 includes a precoding matrix generator 917, a channel feedback configurator 919, a grouping unit 921, and a measure unit 923. Precoding matrix generator 917 may include hardware and/or software adapted to generate precoding matrices based at least in part on information received over the one or more ingress interfaces 905. Precoding matrix generator 917 may be capable of generating precoding matrices in a variety of different ways. For example, precoding matrix generator 917 may use instantaneous channel feedback received over the one or more ingress interfaces 905 to generate precoding matrices used in a first stage of precoding. As another example, precoding matrix generator 917 may use statistical information received over the one or more ingress interfaces 905 to generate precoding matrices used in a second stage of precoding.

Grouping unit 919 may include hardware and/or software adapted to group receiving devices based at least in part on information received over the one or more ingress interfaces 905. For example, grouping unit 919 may group receiving devices into a plurality of channel feedback groups based on statistical channel information associated with the receiving devices as well as individual measures of each of the receiving devices. As another example, grouping unit 919 may group receiving devices into a plurality of channel feedback groups based on statistical channel information associated with the receiving devices. Channel feedback configurator 921 may include hardware and/or software adapted to generate precoding matrices based at least in part on information received over the one or more ingress interfaces 905. For example, channel feedback configurator 921 may configure inter-group channel feedback based on statistical channel information associated with the receiving devices. Measure unit 923 may include hardware and/or software adapted to group receiving devices based at least in part on information received over the one or more ingress interfaces 905. For example, measure unit 923 may generate a measure, including one of a chordal distance, a Fubini-Study distance, a weighted likelihood similarity measure, or a subspace projection similarity measure, for each of the receiving devices.

FIG. 9B illustrates a block diagram of a second embodiment transmitting device 950. Transmitting device 950 is adapted to precode an outgoing data stream in multiple stages. As shown in FIG. 9B, transmitting device 950 includes one or more ingress interfaces 955, and one or more egress interfaces 960. The one or more ingress interfaces 905 may be configured to receive information (e.g., instantaneous channel feedback, statistical channel information, etc.) from devices (e.g., receiving devices) in a wireless network, and the one or more egress interfaces 910 may be configured to send precoded data streams to devices (e.g., receiving devices) in the wireless network. Transmitting device 950 also includes a grouping unit 965, a grouping unit 965, a multiplier 975, and a measure unit 980.

Grouping unit 965 may include hardware and/or software adapted to group receiving devices based at least in part on information received over the one or more ingress interfaces 955. For example, grouping unit 965 may group receiving devices into a plurality of receiving device groups based on statistical channel information associated with the receiving devices. As another example, grouping unit 965 may group receiving devices into groupings of channel feedback devices based on statistical channel information associated with the receiving devices as well as individual measures of each of the receiving devices. Precoding matrix generator 970 may include hardware and/or software adapted to generate precoding matrices based at least in part on information received over the one or more ingress interfaces 955. Precoding matrix generator 970 may be capable of generating precoding matrices in a variety of different ways. For example, precoding matrix generator 970 may use instantaneous channel feedback received over the one or more ingress interfaces 955 to generate precoding matrices used in a first stage of precoding. As another example, precoding matrix generator 970 may use statistical channel information received over the one or more ingress interfaces 955 to generate precoding matrices used in a second stage of precoding.

Multiplier 975 may include hardware and/or software adapted to multiply outgoing data streams with precoding matrices generated by precoding matrix generator 970. Measure unit 980 may include hardware and/or software adapted to group receiving devices based at least in part on information received over the one or more ingress interfaces 955. For example, measure unit 980 may generate a measure, including one of a chordal distance, a Fubini-Study distance, a weighted likelihood similarity measure, or a subspace projection similarity measure, for each of the receiving devices.

As mentioned above, components of the embodiment transmitting devices 900 and 950 may be hardware, software, or a combination thereof. Each component may be referred to as a unit or module. In one embodiment, one or more components of the embodiment transmitting devices 900 and 950 are integrated circuits, such as field programmable gate arrays (FPGAs) or application-specific integrated circuits (ASICs).

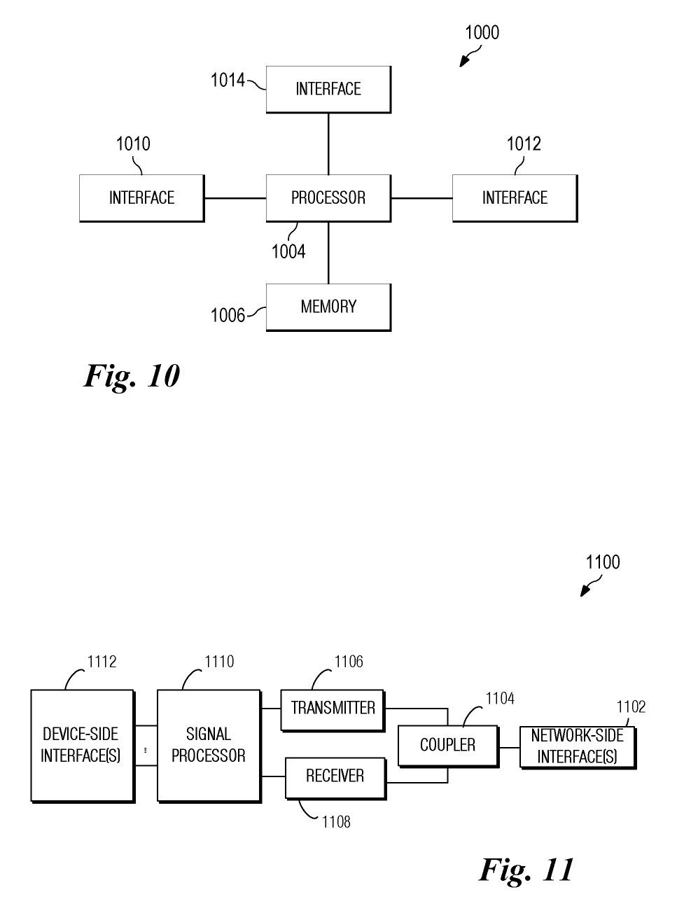

FIG. 10 illustrates a block diagram of an embodiment processing system 1000 for performing methods described herein, which may be installed in a host device. As shown, the processing system 1000 includes a processor 1004, a memory 1006, and interfaces 1010-1014, which may (or may not) be arranged as shown in FIG. 10. The processor 1004 may be any component or collection of components adapted to perform computations and/or other processing related tasks, and the memory 1006 may be any component or collection of components adapted to store programming and/or instructions for execution by the processor 1004. In an embodiment, the memory 1006 includes a non-transitory computer readable medium. The interfaces 1010, 1012, 1014 may be any component or collection of components that allow the processing system 1000 to communicate with other devices/components and/or a user. For example, one or more of the interfaces 1010, 1012, 1014 may be adapted to communicate data, control, or management messages from the processor 1004 to applications installed on the host device and/or a remote device. As another example, one or more of the interfaces 1010, 1012, 1014 may be adapted to allow a user or user device (e.g., personal computer (PC), etc.) to interact/communicate with the processing system 1000. The processing system 1000 may include additional components not depicted in FIG. 10, such as long term storage (e.g., non-volatile memory, etc.).

In some embodiments, the processing system 1000 is included in a network device that is accessing, or part otherwise of, a telecommunications network. In one example, the processing system 1000 is in a network-side device in a wireless or wireline telecommunications network, such as a base station, a relay station, a scheduler, a controller, a gateway, a router, an applications server, or any other device in the telecommunications network. In other embodiments, the processing system 1000 is in a user-side device accessing a wireless or wireline telecommunications network, such as a mobile station, a user equipment (UE), a personal computer (PC), a tablet, a wearable communications device (e.g., a smartwatch, etc.), or any other device adapted to access a telecommunications network.

In some embodiments, one or more of the interfaces 1010, 1012, 1014 connects the processing system 1000 to a transceiver adapted to transmit and receive signaling over the telecommunications network. FIG. 11 illustrates a block diagram of a transceiver 1100 adapted to transmit and receive signaling over a telecommunications network. The transceiver 1100 may be installed in a host device. As shown, the transceiver 1100 comprises a network-side interface 1102, a coupler 1104, a transmitter 1106, a receiver 1108, a signal processor 1110, and a device-side interface 1112. The network-side interface 1102 may include any component or collection of components adapted to transmit or receive signaling over a wireless or wireline telecommunications network. The coupler 1104 may include any component or collection of components adapted to facilitate bi-directional communication over the network-side interface 1102. The transmitter 1106 may include any component or collection of components (e.g., up-converter, power amplifier, etc.) adapted to convert a baseband signal into a modulated carrier signal suitable for transmission over the network-side interface 1102. The receiver 1108 may include any component or collection of components (e.g., down-converter, low noise amplifier, etc.) adapted to convert a carrier signal received over the network-side interface 1102 into a baseband signal. The signal processor 1110 may include any component or collection of components adapted to convert a baseband signal into a data signal suitable for communication over the device-side interface(s) 1112, or vice-versa. The device-side interface(s) 1112 may include any component or collection of components adapted to communicate data-signals between the signal processor 1110 and components within the host device (e.g., the processing system 1000, local area network (LAN) ports, etc.).

The transceiver 1100 may transmit and receive signaling over any type of communications medium. In some embodiments, the transceiver 1100 transmits and receives signaling over a wireless medium. For example, the transceiver 1100 may be a wireless transceiver adapted to communicate in accordance with a wireless telecommunications protocol, such as a cellular protocol (e.g., long-term evolution (LTE), etc.), a wireless local area network (WLAN) protocol (e.g., Wi-Fi, etc.), or any other type of wireless protocol (e.g., Bluetooth, near field communication (NFC), etc.). In such embodiments, the network-side interface 1102 comprises one or more antenna/radiating elements. For example, the network-side interface 1102 may include a single antenna, multiple separate antennas, or a multi-antenna array configured for multi-layer communication, e.g., single input multiple output (SIMO), multiple input single output (MISO), multiple input multiple output (MIMO), etc. In other embodiments, the transceiver 1100 transmits and receives signaling over a wireline medium, e.g., twisted-pair cable, coaxial cable, optical fiber, etc. Specific processing systems and/or transceivers may utilize all of the components shown, or only a subset of the components, and levels of integration may vary from device to device.

Although the present disclosure and its advantages have been described in detail, it should be understood that various changes, substitutions and alterations can be made herein without departing from the spirit and scope of the disclosure as defined by the appended claims.

What is claimed is:

1. A method for performing precoded communications, the method comprising:
precoding in a first stage of a transmitting device, outgoing data streams with first precoding matrices generated in accordance with instantaneous channel feedback received from receiving devices, wherein a configuration of the instantaneous channel feedback is determined in accordance with statistical channel information and individual measures of the receiving devices, thereby producing first precoded data streams;
precoding in a second stage of the transmitting device, the first precoded data streams with second precoding matrices generated in accordance with the statistical channel information associated with the receiving devices, thereby producing second precoded data streams; and
transmitting, by the transmitting device, the second precoded data streams to the receiving devices.

2. The method of claim 1, wherein the instantaneous channel feedback comprises intra-group channel feedback and inter-group channel feedback.

3. The method of claim 2, wherein precoding in the first stage comprises:
grouping the receiving devices into a plurality of channel feedback groups in accordance with the statistical channel information associated with the receiving devices and the individual measures of each of the receiving devices;
determining the configuration of the inter-group channel feedback in accordance with the statistical channel information associated with the receiving devices;
generating a first precoding matrix for each channel feedback group in the plurality of channel feedback groups, wherein the first precoding matrix is generated in accordance with the intra-group and inter-group channel feedback received from the receiving devices; and
applying the first precoding matrices to the data streams.

4. The method of claim 3, wherein the individual measures comprises one of a chordal distance, a Fubini-Study distance, a weighted likelihood similarity measure, or a subspace projection similarity measure.

5. The method of claim 3, wherein each channel feedback group comprises receiving devices from a first receiving device group and at least one receiving device from a second receiving device group.

6. The method of claim 1, wherein the statistical channel information of the receiving devices are obtained from feedback received from the receiving devices or from uplink measurements with an adjustment in accordance with carrier frequency.

7. The method of claim 1, wherein precoding in the second stage comprises:
grouping the receiving devices into a plurality of receiving device groups in accordance with the statistical channel information associated with the receiving devices;
generating a second precoding matrix for each receiving device group in the plurality of receiving device groups, where the second precoding matrix is generated in accordance with the statistical channel information associated with the receiving devices in a corresponding receiving device group; and
applying the second precoding matrices to the first precoded data streams.

8. The method of claim 7, wherein a receiving device group comprises receiving devices with associated statistical channel information that differ by less than a specified threshold.

9. The method of claim 7, wherein a receiving device group comprises receiving devices with associated statistical channel information that have a distance measure or a similarity measure that differ by less than a specified threshold.

10. A method for digital communications, the method comprising:
determining, by a transmitting device, groupings of receiving devices in accordance with statistical channel information associated with the receiving devices, thereby producing a plurality of receiving device groups;
generating, by the transmitting device, a second precoding matrix for each receiving device group of the plurality of receiving device groups, wherein the second precoding matrix is generated in accordance with the statistical channel information associated with the receiving devices;
determining, by the transmitting device, groupings of channel feedback devices in accordance with the statistical channel information associated with the receiving devices and individual measures of each of the receiving devices, thereby producing a plurality of channel feedback groups;
generating, by the transmitting device, a first precoding matrix for each channel feedback group of the plurality of channel feedback groups, where the first precoding matrix is generated in accordance with instantaneous channel feedback received from the receiving devices; and
multiplying, by the transmitting device, outgoing data streams with the first precoding matrix and the second precoding matrix.

11. The method of claim 10, further comprising:
determining the statistical channel information associated with the receiving devices; and
receiving the instantaneous channel feedback of the receiving devices.

12. The method of claim 11, wherein determining the statistical channel information comprises obtaining the statistical channel information from feedback information received from the receiving devices or from uplink measurements with an adjustment in accordance with carrier frequency.

13. The method of claim 10, wherein multiplying the data streams comprises:
for each channel feedback group, multiplying the outgoing data streams intended for receiving devices in the channel feedback group with a first precoding matrix associated with the channel feedback group, thereby producing first precoded data streams; and
for each receiving device group, multiplying the first precoded data streams intended for receiving devices in the receiving device group with a second precoding matrix associated with the receiving device group, thereby producing second precoded data streams.

14. The method of claim 10, wherein the instantaneous channel feedback comprises intra-group channel feedback and inter-group channel feedback.

15. The method of claim 10, wherein the individual measures comprises at least one of a chordal distance, a Fubini-Study distance, a weighted likelihood similarity measure, or a subspace projection similarity measure.

16. A non-transitory computer-readable medium storing programming for execution by a processor, the programming including instructions to:
precode in a first stage of a transmitting device, outgoing data streams with first precoding matrices generated in accordance with instantaneous channel feedback received from receiving devices, wherein a configuration of the instantaneous channel feedback is determined in accordance with statistical channel information and individual measures of the receiving devices, thereby producing first precoded data streams;
precode in a second stage of the transmitting device, the first precoded data streams with second precoding matrices generated in accordance with the statistical channel information associated with the receiving devices, thereby producing second precoded data streams; and
transmit the second precoded data streams to the receiving devices.

17. The non-transitory computer-readable medium of claim 16, wherein the instantaneous channel feedback comprises intra-group channel feedback and inter-group channel feedback.

18. The non-transitory computer-readable medium of claim 17, wherein the programming further includes instructions to:
group the receiving devices into a plurality of channel feedback groups in accordance with the statistical channel information associated with the receiving devices and the individual measures of each of the receiving devices;
determine the configuration of the inter-group channel feedback in accordance with the statistical channel information associated with the receiving devices;
generate a first precoding matrix for each channel feedback group in the plurality of channel feedback groups, wherein the first precoding matrix is generated in accordance with the intra-group and inter-group channel feedback received from the receiving devices; and
apply the first precoding matrices to the data streams.

19. The non-transitory computer-readable medium of claim 16, wherein the programming further includes instructions to:
group the receiving devices into a plurality of receiving device groups in accordance with the statistical channel information associated with the receiving devices;
generate a second precoding matrix for each receiving device group in the plurality of receiving device groups, where the second precoding matrix is generated in accordance with the statistical channel information associated with the receiving devices in a corresponding receiving device group; and
apply the second precoding matrices to the first precoded data streams.

20. A non-transitory computer-readable medium storing programming for execution by a processor, the programming including instructions to:
determine groupings of receiving devices in accordance with statistical channel information associated with the receiving devices, thereby producing a plurality of receiving device groups;
generate a second precoding matrix for each receiving device group of the plurality of receiving device groups, wherein the second precoding matrix is generated in accordance with the statistical channel information associated with the receiving devices;
determine groupings of channel feedback devices in accordance with the statistical channel information associated with the receiving devices and individual measures of each of the receiving devices, thereby producing a plurality of channel feedback groups;
generate a first precoding matrix for each channel feedback group of the plurality of channel feedback groups, where the first precoding matrix is generated in accordance with instantaneous channel feedback received from the receiving devices; and
multiply outgoing data streams with the first precoding matrix and the second precoding matrix.

21. The non-transitory computer-readable medium of claim 20, wherein the programming further includes instructions to:
determine the statistical channel information associated with the receiving devices; and
receive the instantaneous channel feedback of the receiving devices.

22. The non-transitory computer-readable medium of claim 21, wherein the programming further includes instructions to obtain the statistical channel information from feedback information received from the receiving devices or from uplink measurements with an adjustment in accordance with carrier frequency.

23. The non-transitory computer-readable medium of claim 21, wherein the programming further includes instructions to:
for each channel feedback group, multiply the outgoing data streams intended for receiving devices in the channel feedback group with a first precoding matrix associated with the channel feedback group, thereby producing first precoded data streams; and
for each receiving device group, multiply the first precoded data streams intended for receiving devices in the receiving device group with a second precoding matrix associated with the receiving device group, thereby producing second precoded data streams.
